(19) United States
(12) Patent Application Publication
(10) Pub. No.: US 2002/0028703 A1
(43) Pub. Date: Mar. 7, 2002

(54) Feeding device for an agricultural vehicle

(76) Inventors: Walter Hirsch, Limbach (DE); Steffen Schlafer, Schifferstadt (DE)

Correspondence Address: Deere & Company, One John Deere Place, Moline, IL, 61265-8098, US

(21) Appl. No.: 09/866,290

(22) Filed: May 25, 2001

(30) Foreign Application Priority Data
May 31, 2000 (DE) 100 27 273.8

(51) Int. Cl. A01F 12/46; A01D 61/00

(52) U.S. Cl. 460/114; 460/23; 56/16.6; 56/16.4 R

(57) ABSTRACT

The present invention relates to a feeding device of an agricultural vehicle having a first auger, arranged on the floor of a collecting device for harvested crop. A second auger receives the harvested crop from the first auger. The second auger extends, at least across a portion of its length, at an angle to the longitudinal direction of the first auger. A flexible continuous feeding spiral extends through the first and second augers. The feeding spiral (44) is preferably flexible and coreless.

### FIELD OF THE INVENTION

The present invention is directed to a feeding device for an agricultural vehicle wherein a flexible continuous feeding spiral forms part of a first auger arranged on the floor of a collecting device for grain and a second auger which receives the grain from the first auger and which extends, at least across a portion of its length, at an angle to the longitudinal direction of the first auger.

### BACKGROUND OF THE INVENTION

Known self-propelled combines (DE 196 06 730 A) are provided with devices for emptying the grain tank which have several augers. A first auger extends across the width of the floor of the grain tank and directs the grain to a second auger which is arranged in a first, vertically extending section of a discharge pipe which is rigid. The first section of the discharge pipe is divided into two parts, so that its upper part can be pivoted about a vertically extending axis together with the approximately horizontally extending second section of the discharge pipe. In the second section of the discharge pipe, a third auger is located. Here, it is to be regarded as disadvantageous that the drives of the three augers and the bearings, especially for the third auger, narrow the cross-section of the discharge pipe.

In JP 09 117 219 A, a combine with a discharge device for a grain tank is described, wherein a first horizontal auger is mounted on the floor of the grain tank and directs the grain to a second auger which is arranged in a flexible discharge pipe. Also here, two separated augers are provided, so that separate drives are required.

### SUMMARY OF THE INVENTION

It is an object of the present invention to provide a reliable, cost-efficient and mechanically simple feeding device for harvested crops.

It is proposed to provide first and second augers with a continuous feeding spiral. The continuous feeding spiral extends across the length of the first auger on the floor of the collecting device as well as across the length of the second auger which is arranged, at least in a portion of its length, at an angle with respect to the first auger.

In order to be able to realize the angle between the first and the second auger, the feeding spiral is advantageously flexible and preferably has no central longitudinally extending support shaft.

The second auger may also have curves and bends to which the flexible, bendable feeding spiral adapts. It may extend, either entirely or across a partial area, in an oblique or straight line in upward or downward direction.

Since the continuous feeding spiral is to be driven only at one end, no drive is needed for one of the augers. The driving of the feeding spiral may take place from a side wall of the collecting device. Also, no bearings for the feeding spiral are required since it supports itself on the walls of a pipe of the auger in which it is arranged.

In particular, the invention can find application in the case of an emptying device for a grain tank of a combine. The first auger gathers the threshed grain on the floor of the grain tank and the second auger corresponds to the discharge pipe. Thus, the common, continuous feeding spiral extends across the floor and through the discharge pipe. It is also conceivable to arrange the collecting device below a sieve arrangement and to collect the cleaned grain with the first auger and to direct it with the second auger, serving as an elevator for clean grain, to the grain tank. Furthermore, the first auger may serve for gathering tailings, while the second auger again directs the tailings toward a threshing arrangement.

The invention may also find application on so-called tank trucks, which have a container and are loaded with grain by a combine. The feeding device of the invention serves for emptying the container of the tank truck. The invention may also be used on sowing vehicles which are loaded with seeds. The feeding device of the invention moves the seeds from the sowing vehicle into the seed container of a sowing or drill machine.

### BRIEF DESCRIPTION OF THE DRAWINGS

FIG. 1 is a sideview of a combine with a feeding device of the present invention.

FIG. 2 is a cross-sectional view through the grain tank and the discharge pipe of the combine of FIG. 1.

### DETAILED DESCRIPTION

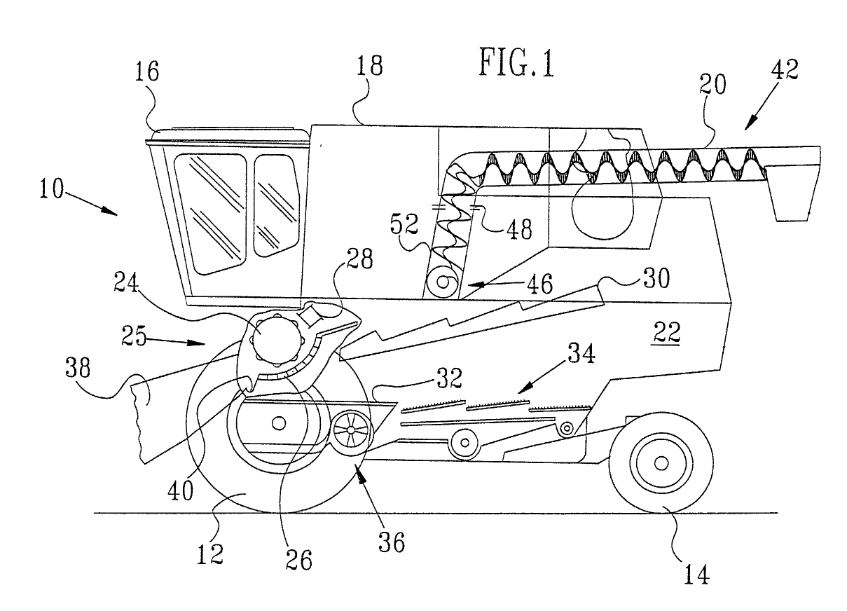

A harvesting machine, as shown in FIG. 1, in the form of a self-propelled combine 10 is carried on forward driven front wheels 12 and rear steering wheels 14. The combine is provided with an operator's compartment 16 from which the combine is controlled by a driver. The present invention can be used on other agricultural harvesting machines, for example, a stationary thresher, an experimental threshing arrangement or the like. A grain tank 18 is located behind the operator's compartment 16. The grain tank 18 is used to temporarily store clean grain during combine operations. The clean grain is expelled from the grain tank 18 by a discharge pipe 20. The grain tank 18 rests on a frame 22 formed by the combine side sheets. Typically, a standing crop is harvested by a harvesting platform or corn head, not shown, and directed through feeder house 38 past stone trap 40 to a threshing assembly 25. The illustrated threshing assembly 25 comprises a transverse threshing cylinder 24, a concave 26 and a beater 28. The threshing assembly 25 separates the harvested crop received from the feeder house 38 into its large and small components. Additional separation of the large components from the small components is carried out by straw walkers 30. The large components, straw, is directed out the rear of the combine by the straw walkers 30. The grain pan 32 receives clean grain and chaff from the threshing assembly 25 and straw walkers 30 and directs the clean grain and chaff to sieves 34. An air blast from cleaning fan 36 blasts the chaff out the rear of the combine and the remaining clean grain falls through the sieves 34 to the floor of the combine. The clean grain is raised from the floor by a clean grain elevator, not shown, to the grain tank 18.

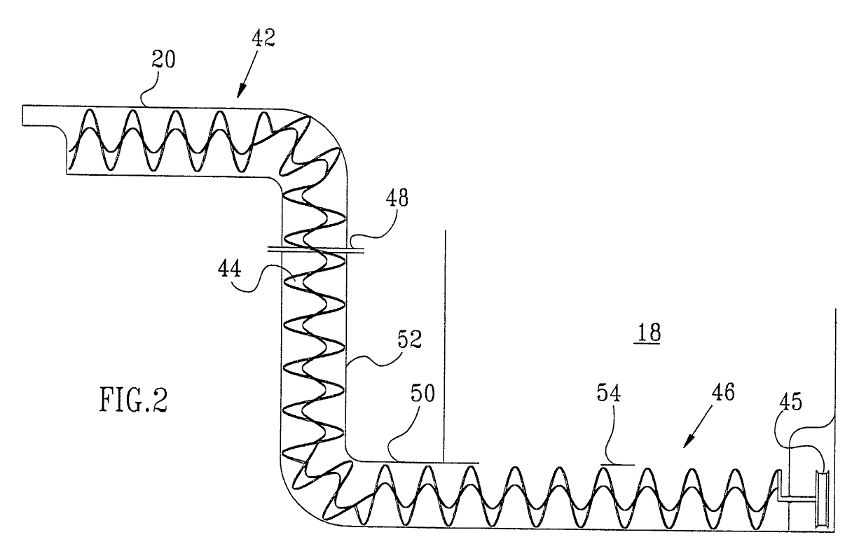

As shown in FIG. 2, the floor of the grain tank 18 is provided with a first auger 46 having a feeding spiral. The first auger 46 extends across the width of the grain tank 18 and horizontally transports the threshed crop deposited in the grain tank 18 laterally toward the left, as shown in FIG. 2. Naturally, it would also be conceivable for the auger 46 to extend in the driving direction of the combine 10, longitudinally across the length of the grain tank. On a side wall of the grain tank 18, drawn in FIG. 2 on the right side, a drive 45 is arranged for turning the feeding spiral 44 of the auger 46 as required. The area toward the end of the auger 46, opposite the drive 45, extends inside a horizontal pipe 50, which makes available a lateral and vertical guidance of the feeding spirals 44. In the center, between the side wall with the drive 45 and the pipe 50, a short channel 54 is provided which surrounds and guides the feeding spiral 44 vertically and horizontally and, in particular in the presence of greater loads, prevents the deformation of the feeding spiral 44.

The feeding spiral 44 is manufactured from a flexible and bendable material and is not provided with a central longitudinally extending support. For this reason, it can be placed into curved spaces and can transport the crop around bends. Such feeding spirals make possible a transport with minimal wear and tear and can be obtained, for example, from the Wildfellner Company, of Austria.

A substantially vertical pipe 52 is connected to the horizontal pipe 50. The feeding spiral 44 extends upwardly through the vertical pipe 52 and directs the crop in upward direction. A right angle bend is provided between the horizontal pipe 50 and the vertical pipe 52. Due to the already mentioned flexibility of the feeding spiral 44, this bend can be realized without problems.

At the upper end of the vertical pipe 52, a swivel ring 48 is arranged which connects the vertical pipe 52 with the discharge pipe 20. The discharge pipe 20 is mounted in such a way as to be pivotable by the swivel ring 48 about a vertically extending axis relative to the stationary vertical pipe 52. As such it is possible to pivot the discharge pipe 20 toward the rear during transport and outwardly to the side during discharge into an appropriate wagon or the like. The discharge pipe 20 has a short vertical section where it is connected to the swivel ring 48. The short vertical section is bent to transition into a relatively long, horizontal section. The discharge pipe 20 is typically made of metal as are the vertical pipe 52 and the horizontal pipe 50, however, it may also be manufactured from a plastic.

The continuous, one-piece feeding spiral 44 extends through the discharge pipe up to its outer end on the discharge side.

The first auger 46 is formed by the lower part of the feeding spiral 44, extending along the floor of the grain tank 18. The remaining portion of the feeding spiral 44 provides a second auger 42 which extends at first in upward direction and then again horizontally through the discharge pipe 20. Only a single drive 45 of the discharge device of the grain tank 18 is necessary. In addition, the typical bearings concentrated in the cross section of the discharge pipe 20 become unnecessary. Thus, a mechanically very simple and reliable feeding device is obtained. Also, the elevator for clean grain and/or the tailings elevator may be equipped with augers with continuous spirals.

Having described the preferred embodiment, it will become apparent that various modifications can be made without departing from the scope of the invention as defined in the accompanying claims.

1. A feeding device of an agricultural vehicle having a first auger arranged in a collection device holding grain, the collection device having a floor on which the first auger is arranged, the first auger is designed to direct grain from the collection device in a longitudinal direction, the first auger directs grain in the collection device to a second auger, extending at least across a part of its length at an angle to the longitudinal direction of the first auger, characterized in that the first auger and the second auger have a continuous feeding spiral.

2. A feeding device as defined by claim 1 wherein the continuous feeding spiral is flexible.

3. A feeding device as defined by claim 2 wherein the second auger extends, at least across a partial area of its length, in a vertical direction.

4. A feeding device as defined by claim 3 wherein the feeding spiral is driven by a drive which is arranged at a side wall of the collection device.

5. A feeding device as defined by claim 4 wherein the collection device is a grain tank and the second auger is arranged in a discharge pipe of the grain tank.

6. An agricultural combine comprising:
a collection device for collecting grain, the collection device having a floor;
a first auger arranged on the floor of the collection device and extending in the longitudinal direction for expelling grain from the collection device in the longitudinal direction;
a second auger having a length, a portion of the length of the second auger extending at an angle to the longitudinal direction of the first auger, the second auger receiving expelled grain from the first auger;
whereby the first auger and the second auger have a continuous feeding spiral.

7. An agricultural combine as defined by claim 6 wherein the continuous feeding spiral is flexible.

8. An agricultural combine as defined by claim 7 wherein the first auger extends horizontally and the portion of the length of the second auger extending at an angle to the longitudinal direction of the first auger extends vertically.

9. An agricultural combine as defined by claim 8 wherein the feeding spiral is driven by a drive arranged at a side wall of the collection device.

10. An agricultural combine as defined by claim 9 wherein the collection device is a grain tank and the second auger is arranged in a discharge pipe.

11. An agricultural combine as defined by claim 9 wherein the continuous feeding spiral is not provided with a longitudinally extending central support.
